(19) United States
(12) Patent Application Publication
(10) Pub. No.: US 2017/0259995 A1
(43) Pub. Date: Sep. 14, 2017

(54) Mechanical Apparatus for Compressing Waste

(71) Applicant: Fernando Russo, Chicago, IL (US)

(72) Inventor: Fernando Russo, Chicago, IL (US)

(21) Appl. No.: 15/067,456

(22) Filed: Mar. 11, 2016

(51) Int. Cl. B65F 1/14; B65F 1/16

(52) U.S. Cl. CPC B65F 1/1405; B65F 1/16; B65F 2210/12

(57) ABSTRACT

The technical disclosure relates to a mechanical device that compresses waste in a garbage can. The embodiments descried in the technical disclosure provide the benefit of compacting waste without having to touch the waste, and also using trash bags more efficiently. The technical disclosure describes a shaft extending through a lid and connected to a star-shaped polygon that pushes down on waste. The star-shaped polygon provides improved performance. Additional embodiments are further described herein.

### FIELD OF THE INVENTION

The present invention generally relates to the field of mechanical devices for compressing waste in a household and more particularly to an improved device for compacting the contents of a garbage can.

### BACKGROUND OF THE INVENTION

Trash compactors are used to compact trash, which may save space in a trash can and reduce the number of trash bags used. There are numerous considerations in the design and manufacture of trash compactors. For example, prior art trash compactors may use a flat, circular disk for compacting trash. Such flat, circular disks are disadvantageous because they may rip trash bags. Moreover, the prior art compacting disks provided poor aerodynamics, which leads to inefficient trash compacting and may cause undesirable up-drafts of air in the trash can.

It would be extremely advantageous to have an advanced trash compacting apparatus which can compact or compress waste without the problems of prior art devices.

### SUMMARY OF THE INVENTION

The present disclosure relates to an apparatus for compressing waste in a garbage can. One aspect of the disclosure recognizes that the volume of waste can be reduced by compressing waste in a garbage can, thereby reducing the frequency with which the garbage can must be emptied and reducing the number of plastic bags used in the garbage can. One aspect of the disclosure relates to an apparatus having a handle attached to a shaft which runs through a lid and is connected to a compression element. By pushing the handle, a user drives the shaft, and by extension the compression element, to push waste down into a garbage bin without having to touch the waste by hand. The disclosure may include a spring biased to return the knob and shaft to their rest position.

Another aspect of the disclosure recognizes that a compression element having a convex configuration is more effective at pushing down waste in a garbage bin. Another aspect of the disclosure recognizes that a compression element having a star-shaped polygon improves performance. Yet another aspect of the disclosure recognizes that a star-shaped polygon having flanges on its tips reduces the likelihood that the compression element will tear a trash bag as it compresses waste. Not all aspects of the summary will be addressed in each and every embodiment of the present disclosure, as set forth in further detail below.

### BRIEF DESCRIPTION OF THE DRAWINGS

FIG. 1 is a bottom perspective of one embodiment of the present disclosure in its rest position.

FIG. 2 is a bottom perspective of one embodiment of the present disclosure in its extended position.

FIG. 3 is a top perspective of one embodiment of the present disclosure in its rest position.

FIG. 4 is a top perspective of one embodiment of the present disclosure in its extended position.

FIG. 5 is a side perspective of one embodiment of the present disclosure in its rest position.

FIG. 6 is a side perspective of one embodiment of the present disclosure in its extended position.

FIG. 7 is a side perspective of one embodiment of the present disclosure in its rest position.

### DETAILED DESCRIPTION OF EMBODIMENTS OF THE INVENTION

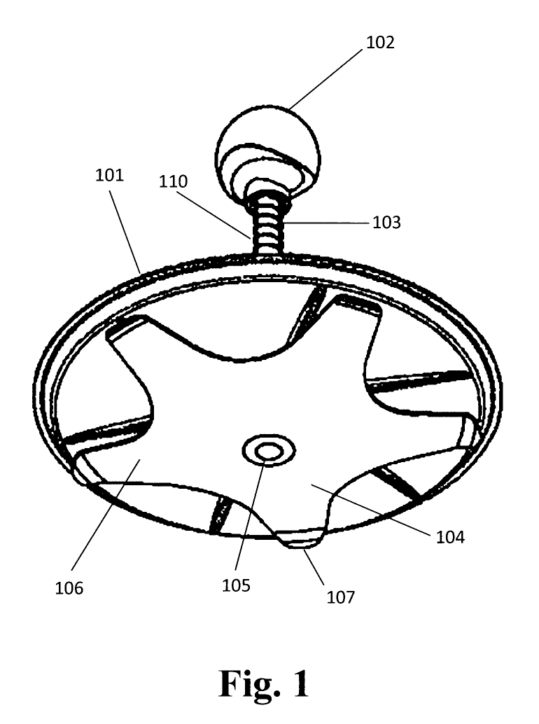

Referring now to the drawings, in which like numerals refer to like elements throughout the several views, FIGS. 1-7 show embodiments of the mechanical device for compressing waste in a garbage bin. The mechanical device may be hand-held and used to compress waste in a garbage can, but a person of skill would recognize that other applications are also possible. Certain may be used as part of a lid for a garbage can that allows a user to push downwards on a handle attached to a compression surface for compressing waste in the garbage can. Pushing the handle through the lid 101 causes the compression surface to extend through the lid and compress waste in the garbage bin. FIG. 1 shows the compression surface 104 connected to a first end of a shaft 103 which extends through an opening in lid 101. The lid 101 may have a circumference substantially similar to the circumference of a cylindrical trash can to ensure a close fit between the lid 101 and a trash can. A screw or bolt 105 may be used to secure the compression surface to the shaft 103. The compression surface 104 is preferably detachable from shaft 103 to allow for easy cleaning. A handle 102 is connected to the second end of shaft 103. The handle 102 may be removably connected to the shaft, for example by screw threads. A removable handle 102 may provide the advantage of allowing the unassembled device to be stored in a smaller packaging.

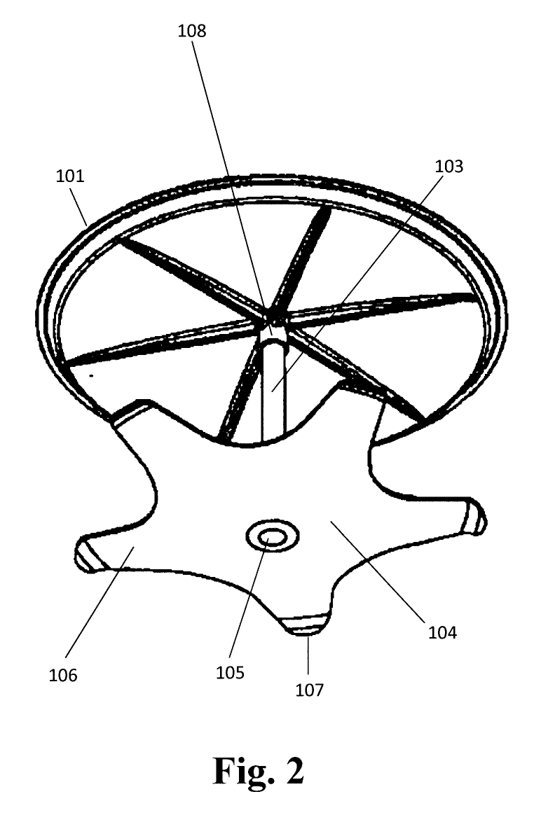

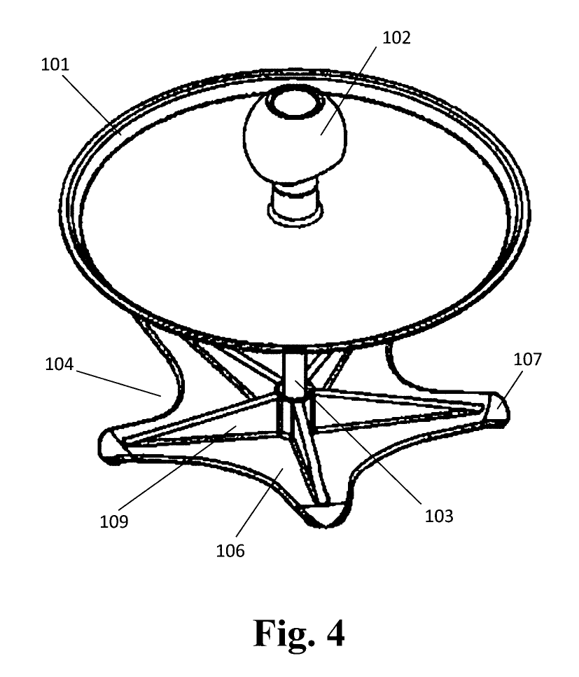

For example, FIG. 2 illustrates the compression surface 104 in its extended position. The shaft 103 is seen extending through the lid 101, thereby forcing the compression surface 104 downward and causing the waste in the garbage bin to compact. Similarly, FIG. 4 illustrates the compression surface 104 in its extended position, as seen from above. The lid 101 may include a sleeve 108 for guiding the shaft 103, and by extension the compression surface 104, upwards and downward in a straight line. Ensuring that the compression surface 104 moves up and down in a straight line is advantageous because it prevents the compression surface 104 from contacting the edge of a garbage bin, which may contain a plastic garbage bag. Contact between the compression surface 104 and a garbage bag is undesirable because it may cause the plastic bag to rip or tear.

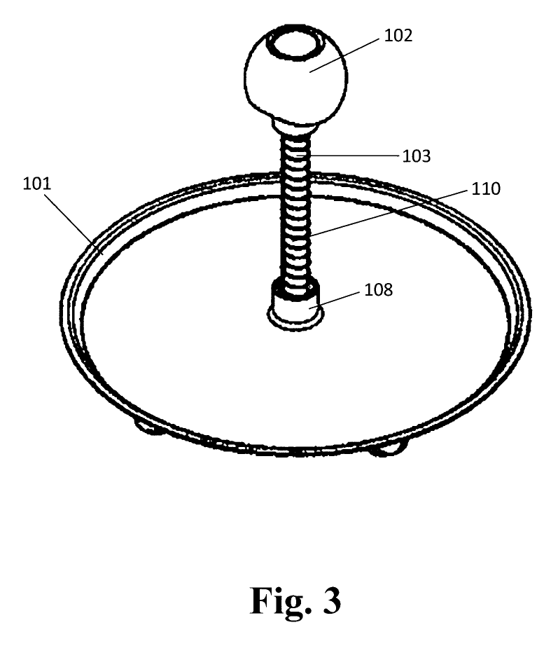

FIG. 3 shows another embodiment of the disclosure which comprises a spring 110 biased to return the shaft 103 to its resting position in the absence of a user's downward pressure. In this example, the spring 110 is a compression spring mounted between the sleeve 108 and the handle 102. The compression spring exerts a force that biases the handle 102, shaft 103, and by extension compression surface 104, into the upright resting position.

Various embodiments of the compression surface are more clearly illustrated in FIGS. 4-7. For example, the compression surface may have a star-shaped polygon, shown in FIG. 4 with five points. The five-point star-shaped polygon surface shown in the figure generally resembles a human hand, but a person of skill in the art would recognize that similar configurations may be used. The star-shaped polygon surface has an advantage of being more aerodynamic than a circular disk. The resulting benefit is a smoother up-and-down motion when a user presses the handle down. By contrast, a user pushing a solid circular disk into a garbage bin will cause air to be pushed to the sides and potentially even upwards, leading to undesirable effects. The air pushed aside by a solid disk may cause the plastic bag to become displaced. It may also lead to waste items being ejected from the garbage bin, or an unpleasant up-draft of air blowing from the garbage bin to the user.

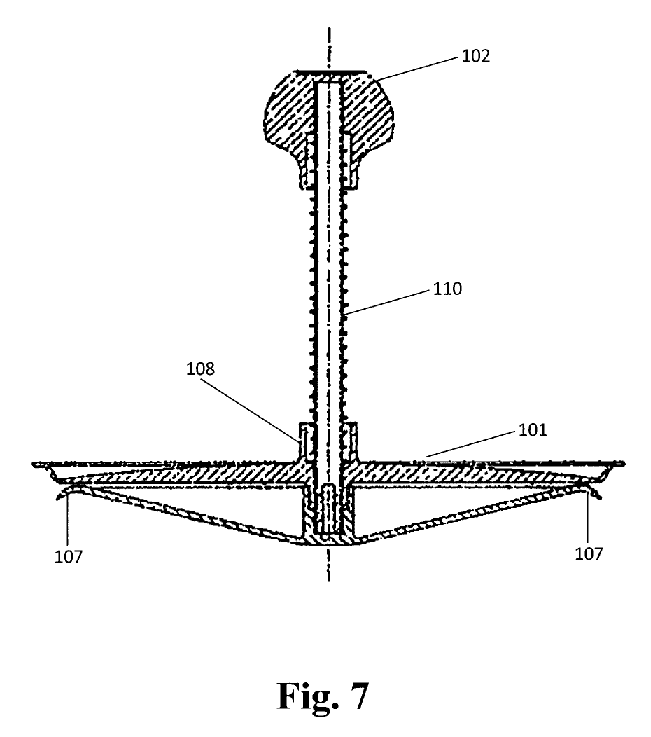

To improve the aerodynamic performance, embodiments of the star-shaped polygon compression surface 104 include five points 106, as seen in FIG. 4 from a top-down view. A baffle 109 may reinforce some or all of the five points 106. Embodiments may additionally include flanges 107 affixed to the end of some or all of the points 106. The flanges 107 are rounded and provide a smooth interface in the event that compression surface 104 contacts a plastic bag in the garbage bin. Without a smooth interface, the compression surface 104 may risk tearing or displacing a plastic bag. FIG. 7 is a cross-section view illustrating the rounded flanges 107.

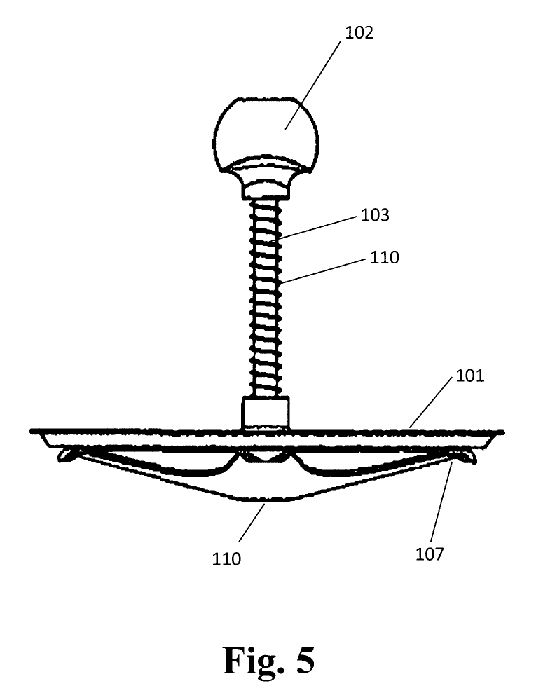

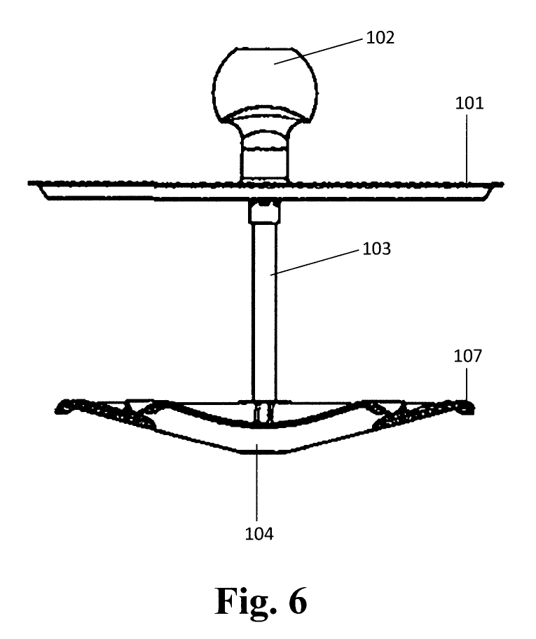

In another embodiment of the disclosure, the compression surface 104 may have a convex curvature, as illustrated for example in FIGS. 5-7. This convex curve provides benefits over a flat surface. The convex curvature provides improved aerodynamics as a user forces the handle 102 and shaft 103 down into the garbage bin. The convex curvature also provides an improved ability to compact trash because of its force distribution. As the user forces the handle 102 and shaft 103 into the down position, for example from FIG. 5 to FIG. 6, the compression surface 104′s inflection point 110 is the first point to contact the waste. The inflection point 110 exerts a larger force on the waste because it has a smaller surface area. The result is that waste is more effectively compacted compared to a flat disk shape and more waste can fit into the garbage can.

Several descriptions and illustrations have been provided to aid in understanding the present disclosure. One with skill in the art will realize the numerous changes and variations can be made without departing from the spirit of the invention. Each of these changes and variations is within the scope of the present disclosure.

What is claimed is:

1. A trash-compacting apparatus, comprising:
a lid having an opening;
a shaft having two ends and extending through the opening;
a handle attached to the first end; and
a compression surface attached to the second end;
wherein the compression surface is a convex star-shaped polygon and includes five points, each point having an end with a flange.

2. The trash-compacting apparatus of claim 1, wherein the lid further includes a sleeve for guiding the shaft in a straight line.

3. The trash compacting apparatus of claim 1, wherein the compression surface is removably attached to the shaft with a bolt.

4. The trash compacting apparatus of claim 1, wherein a compression spring having two ends is attached on one end to the handle and on the other end to the lid and biases the shaft to a resting position.

5. A trash-compacting surface, comprising:
a convex curvature;
five points, each of said five points having a backside reinforced by a baffle;
a flange attached to each of said five points; and
a hole for receiving a bolt;

6. A trash can comprising:
a cylindrical bin having a diameter;
a lid fitting the bin and having substantially the same diameter;
a shaft having two ends;
a handle attached to the first end; and
a convex compression surface removably attached to the second end, the convex compression surface having five points and a flange attached to each point.

7. The trash can of claim 6, further comprising a sleeve on the lid for guiding the shaft in a straight line.

8. The trash can of claim 7, further comprising a compression spring having two ends, one end being connected to the sleeve and the second end being connected to the handle.
